(19) United States
(12) Patent Application Publication
(10) Pub. No.: US 2011/0082798 A1
(43) Pub. Date: Apr. 7, 2011

(54) SYSTEM AND METHOD FOR SECURELY TRANSMITTING DATA ACROSS A SYSTEM LANDSCAPE

(75) Inventors: Mark Michaud, Kirkland (CA); Bernd Lehnert, Neustadt (DE); Bernd Sieren, Wadgassen-Differten (DE); Jürgen Rink, Grossrossein (DE)

(73) Assignee: SAP AG

(21) Appl. No.: 12/573,598

(22) Filed: Oct. 5, 2009

(51) Int. Cl. H04L 9/28; G06Q 20/00

(52) U.S. Cl. 705/71; 705/75

(57) ABSTRACT

A system and method for securely transferring sensitive payment data across a system landscape. The system and method may utilize machine-readable media including program code stored therein executable by one or more processors to perform the transferring of payment data. The transferring of data includes generating and encrypting a data container to combine all sensitive payment data. The encryption logic is configured to automatically transfer keys between systems.

### BACKGROUND

The present invention relates to the field of securing communications across systems. More specifically, the invention relates to securely transferring sensitive data across a system landscape. Sensitive data may be passed between systems in an unsecure environment (e.g. over Internet). To ensure secure transfer of sensitive data, encryption is typically used. However, different systems within the system landscape can employ different encryption mechanisms.

According to Payment Card Industries (PCI) security standards, payment software applications that store, process, or transmit cardholder data as part of authorization or settlement are required to use strong encryption and security protocols to safeguard sensitive cardholder data during transmission across systems. In a retail system landscape, a transaction data log, which may include sensitive data (e.g. credit cardholder data), may be transmitted among different systems. An example of a transaction data log in the retail industry is the TLOG standard.

### SUMMARY

One embodiment of the present invention relates to a computer system comprising machine-readable media having stored therein instructions that when executed cause the computer system to implement a method for transferring data between computer systems. The method includes receiving transaction log in a first computerized system. The transaction log including payment data. The method further includes generating a data container, by a data container generation logic implemented by the instructions stored in the machine-readable media. The data container includes payment data and references to the transaction data. The method further receives a certificate from a second computerized system. The second computerized system uses a first encryption mechanism. The method further includes encrypting the data container, by an encryption logic implemented by the instructions stored in the machine-readable media. The method further includes transmitting the transaction log and the encrypted payment data to a third computerized system.

Another embodiment of the present invention relates to a computer-implemented system for securely transferring credit card data. The system includes a first computerized system, the first computerized system being configured to generate and store keys with corresponding key version identifiers. The system further includes a second computerized system. The second computerized system being configured to receive a transaction log file and generating a data container. The data container contains credit card information and references back to the transaction log file where the credit card information came from. The second computerized system is configured to encrypt the data container using the key received from the first computerized system.

Another embodiment of the present invention relates to a computer system comprising machine-readable media having stored therein instructions that when executed cause the computer system to implement a method for transferring data between computer systems. The method includes receiving transaction data in a first computerized system, from a second computerized system. The transaction data including payment data encrypted by the second computerized system using a first encryption mechanism. The method further includes decrypting the sensitive data with a first key using the first encryption mechanism. The method further includes generating a data container, the data container including decrypted payment data and references to the transaction data generated by a referencing mechanism. The method further includes requesting a second key and a second key version from a third computerized system, the third computerized system managing keys for encryption using a second encryption mechanism. The method further includes encrypting the data container with the first key into an encrypted data container. The method further includes encrypting the encrypted data container and the first key with the second key using the second encryption mechanism into an encrypted data segment. The method further includes transmitting the transaction data, the encrypted data segment, and the second key version to a third computerized system.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic diagram of a retail system landscape, according to one exemplary embodiment;

FIG. 2 is an illustration of a transaction data log file, according to one exemplary embodiment;

FIG. 3 is a tree diagram of a transaction log file, according to one exemplary embodiment;

FIG. 4 is a tree diagram of a data container, according to one exemplary embodiment;

FIG. 5 is a tree diagram of an encrypted data segment, according to one exemplary embodiment;

FIG. 6 is a flowchart relating to processing of a transaction data log by a point of sale store server, according to one exemplary embodiment;

FIGS. 7A-7B are sequence diagrams showing secure transmission of a transaction data log across a system landscape, according to one embodiment;

FIG. 8 is a sequence diagram showing secure transmission of a transaction data log across a system landscape, according to another embodiment; and

FIG. 9 is a sequence diagram showing publishing a newly generated key, according to one embodiment.

### DETAILED DESCRIPTION OF THE EXEMPLARY EMBODIMENTS

Before turning to the figures which illustrate the exemplary embodiments in detail, it should be understood that the disclosure is not limited to the details or methodology set forth in the description or illustrated in the Figures. It should also be understood that the terminology is for the purpose of description only and should not be regarded as limiting.

Referring generally to the Figures, an example of a method and system for securely transmitting sensitive data across a retail systems landscape is shown and described. In the disclosed example, all sensitive information found in a transaction data log(TLOG) is combine into one segment, and the segment is encrypted once. In order to combine all the sensitive information into one segment, a referencing mechanism is used in order to map sensitive information back to where it came from in the original transaction data. The target system that needs to extract sensitive information needs to perform the decrypt operation only once, thus, improving performance, without compromising security.

The systems in the retail system landscape may utilize different encryption mechanisms. The format of the segment that combines all the sensitive information may be adaptable to passing sensitive data using any encryption mechanism.

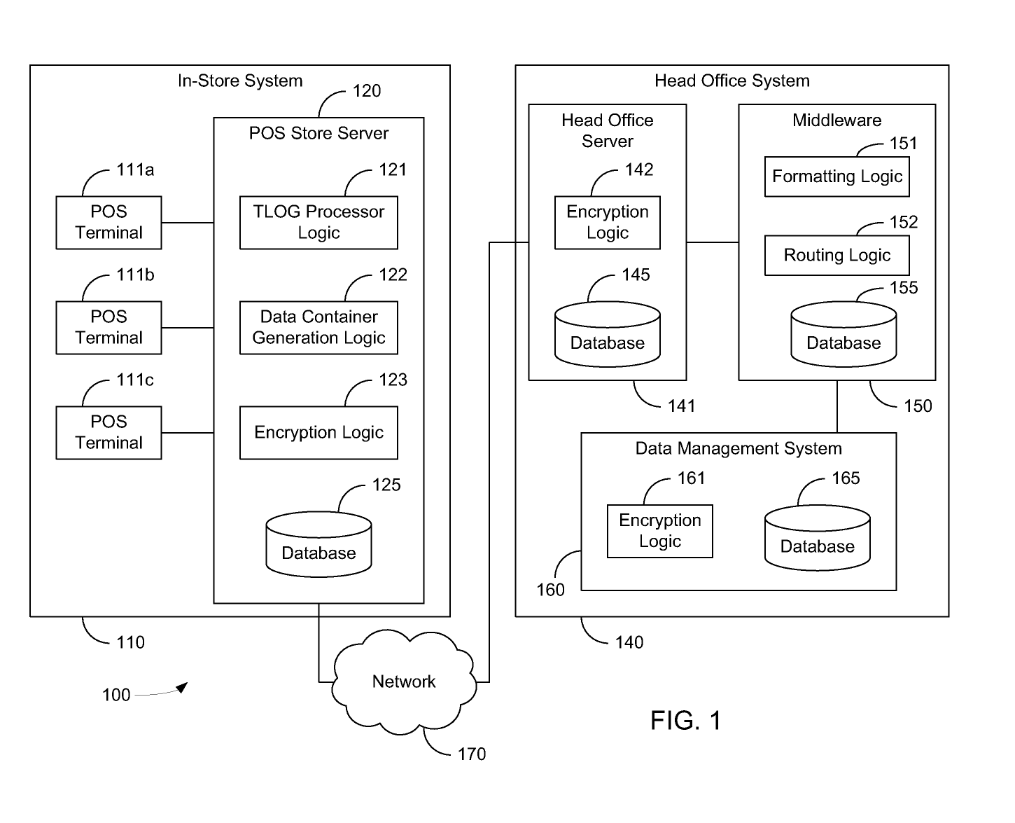

Referring to FIG. 1, FIG. 1 shows a schematic diagram of a retail system landscape 100 according to an example embodiment. The retail system landscape 100 is shown to include an in-store system 110, a head office system 140, and a network 170.

The in-store system 110 is shown to include point-of-sale (POS) terminals 111 and a POS store server 120. In an exemplary embodiment, the in-store system 110 may have several POS terminals 111 that manage the selling process at the store. The POS terminal may be a standard POS terminal, an offline capable POS terminal, or a mobile POS device (Web enabled), which allows for remote operation.

The POS terminals 111 may process regular sales transactions, in which a customer pays for the goods at the POS terminal. A customer settles a transaction with an accepted method of payment. Accepted methods of payment may include paying with cash, credit card, debit card, check, electronic benefit transfer, smart chip card, or any other form of payment for the purchase. When a customer uses a credit card or debit card as a form of payment, the POS terminals 111 may trigger an authorization process. The POS terminals 111 may also support a manual approval process. The POS terminals 111 may also process cancelled transactions, transactions with voided items, non-merchandise transactions (purchases of gift cards or purchases of services related to merchandise, such as merchandise delivery or alterations), post-voided transactions (voiding a transaction that is already completed), returns with cash refunds, exchanges, etc. The POS terminals 111 may consist of a computer, with programs and I/O devices (e.g., keyboard, credit card reader, bar code scanner, etc.), as well as a plurality of peripherals (e.g. displays, printers, etc.). The POS terminals 111 may also utilize a touch-screen technology.

In an exemplary embodiment, the POS terminals 111 may generate transaction log files (e.g., TLOG files) containing a complete record regarding everything that has happened at the POS terminal, and send the TLOGs to the POS store server 120 for further processing. In one embodiment, the POS terminals 111 may be generating and transmitting TLOGs to the POS store server 120 in real-time (or near real-time). In another embodiment, the POS terminals 111 may be generating one or more TLOGs once in a sales day (at the end of the day), or once in any other period of time. The TLOGs may originally be in binary format, ASCII format, XML format, or any other format. TLOGs may be converted into binary, ASCII, XML or any other format, by the POS store server 120, or at any point during the transmission across the retail system landscape 100.

In another embodiment, the POS store server 120 may be responsible for generating TLOGs based on the data received from the POS terminals 111. In this embodiment, the POS terminals 111 may post data collected by the POS terminals 111 to the POS store server database 125.

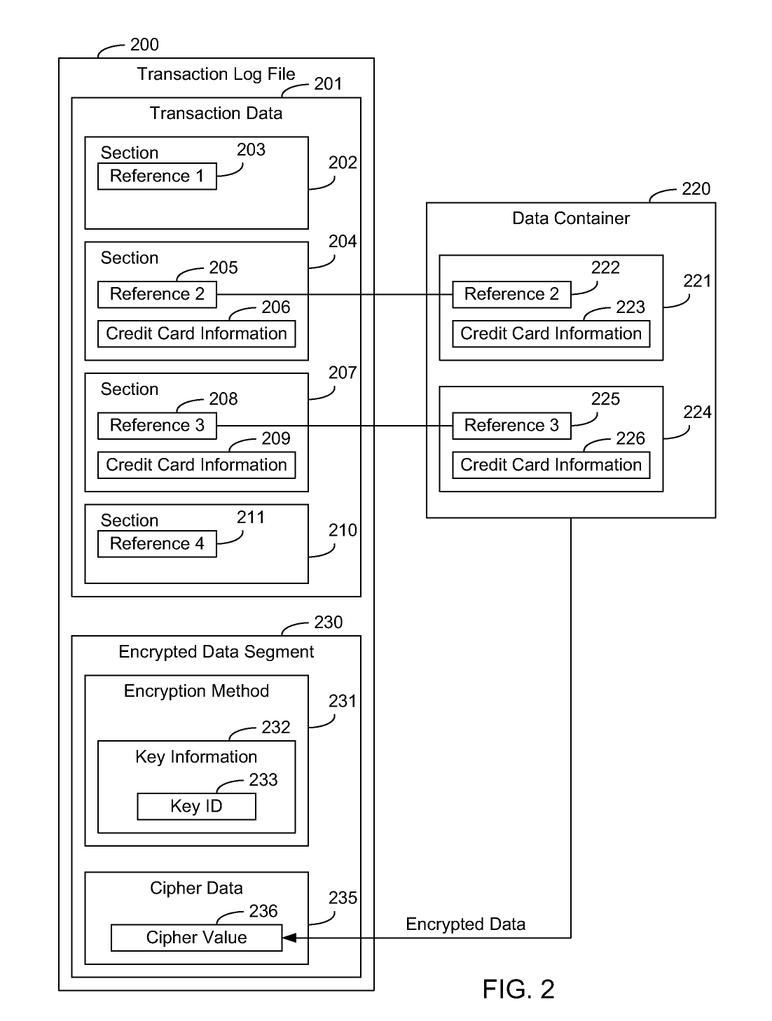

When a customer uses a credit card to make a purchase at a POS terminal 111, the POS terminal may generate a TLOG file that may contain the credit card information. Because the POS terminals 111 may be operating in an unsecure environment, the transaction data containing the credit card information needs to be transferred in a secure way. In an example embodiment, the POS terminals 111 may encrypt the credit card information in the TLOG file. Alternatively, the POS terminals 111 may encrypt the entire contents of the TLOG. The POS terminals 111 may also send the TLOG through a secure channel using SSL protocol, TLS protocol, IPSEC, or any other protocol. In another embodiment, the POS terminals 111 may encrypt sensitive data in the TLOG file using a mechanism illustrated in FIGS. 2-5. The POS terminals 111 are not restricted to any encryption algorithm, and may use any symmetric, asymmetric, or hybrid asymmetric encryption algorithms, including but not limited to RSA scheme (e.g. PKCS#7), DES/DES3, Blowfish, IDEA, SEAL, Mars, RC4, SEED, etc.

In an exemplary embodiment, the head office system 140 is shared among a plurality of in-store systems. The head office system 140 is shown to include a head office server 141, middleware 150, and a data management system 160. In one embodiment, the POS store server 120 may send TLOGs to the head office server 141 across network 170 in real-time (or near real-time), or it can send aggregate or consolidated TLOGs in a batch mode once in a certain period of time (e.g. at the end of a sales day). In an exemplary embodiment, the POS store server 120 may store the generated TLOGs in its database 125 or another secure storage. In an exemplary embodiment, the head office server 141 also stores the received TLOGs in its database 145 or another secure storage.

The middleware 150 is shown to facilitate interaction between the head office server 141 and the data management system 160. In an exemplary embodiment, the middleware 150 may receive a TLOG file from the head office server 141 in a first format. In this embodiment, the middleware 150 may then convert the received TLOG into a format that a target system (e.g. the data management system 142) will understand. The middleware 150 may also receive data from other systems in the head office system 140, such as an enterprise resource planning system, and send the data to the head office server 141 in a format that the head office server 141 understands. In one embodiment, if the data received by the middleware 150 contains any encrypted data, the middleware 150 may decrypt the encrypted data. In this embodiment, the middleware 150 may maintain the encryption method and key information, or the middleware 150 may request it from the sender or the target system, or from any other system that maintains the needed encryption information. In another embodiment, if the transaction data contains any encrypted data, the middleware 150 will not decrypt the encrypted data. In an exemplary embodiment, the middleware 150 may read transaction data files from a file server using a messaging service. In one embodiment, the messaging service may be implemented as a centralized file transfer service utilizing FTP, TCP/IP or any other protocol. In another embodiment, the messaging service may be implemented as a Java Message Service (JMS) Provider. The messaging service may be implemented with various protocols including, but not limited to, FTP, TCP/IP, HTTP, UDP, etc.

In an exemplary embodiment, the POS store server 120 is involved in processing real-time transactions, and the head office server 141 performs back office functions. The head office server 141 may receive transaction data or TLOGs from a plurality of POS store servers. The data management system 160 may perform sales auditing, data cleansing and optimization, and also aggregate the sales data. In an exemplary embodiment, other back end systems such as enterprise resource planning system may provide financial processing and performance monitoring, including store level profit accounting. The enterprise resource planning systems may also support business processes including merchandise management, purchase order management, merchandise distribution, warehouse management, and store execution. The head office system 140 may include other back end systems, not shown in FIG. 1.

The POS store server 120 is shown to include a TLOG processor logic 121, a data container generation logic 122, and an encryption logic 123. Such logics may, in practice, be implemented in a machine (e.g., one or more computers or servers) comprising machine-readable storage media (i.e. cache, memory, flash drive or internal or external hard drive or in a cloud computing environment) having instructions stored therein which are executed by the machine to perform the operations described therein. The POS store server 120 may include volatile memory (e.g. random access memory (RAM)) for storing transaction data and instructions to be executed by a processor. The POS store server 120 may also include non-volatile memory (e.g., a read only memory (ROM)) for storing static information and instructions for the processor.

The TLOG processor logic 121 may be configured to parse the transaction data received from the POS terminals 111 and determine whether the transaction data contains sensitive payment data, such as credit card information. In an example embodiment, the POS terminal 111 may encrypt the credit card information, in which case the encryption logic 123 will decrypt the encrypted credit card data. If the POS store server 120 receives TLOG files from the POS terminals 111, the TLOG processor logic 121 may re-format the received TLOG files. In another embodiment, the TLOG processor logic 121 may generate TLOG files using the POS data received from the POS terminals 111. In one embodiment, the encryption logic 123 may decrypt encrypted data found in the transaction data or TLOGs received from the POS terminals 111. The entire contents of a file received from the POS terminals 111 may be encrypted, or only one or more sections of the file may be encrypted. The encryption logic 123 may store encryption method and key information necessary to decrypt the encrypted POS transaction data. Alternatively, the encryption logic 123 may request the encryption method and key information from the head office server 141 or any other system that has the necessary encryption information, in order to decrypt the encrypted POS transaction data.

The data container generation logic 122 may be configured to generate a data container by combining sensitive information (e.g. credit card data, debit card data etc.) found in the transaction data or TLOG file received from the POS terminals 111 into a single segment. The data container may be generated using a referencing mechanism, such that the generated data container will have references back to the transaction data. In an example embodiment, the data container generation logic 122 may generate and populate a single data container that will include all the credit card data from the transaction data or TLOG file received from the POS terminals 111, with references back to the transaction data. The encryption logic 123 may encrypt the generated data container with encryption information requested from the target system (e.g. the head office server 141). In another embodiment, the encryption information such as public key may be stored by the POS store server 120 in secure storage.

In one embodiment, the encrypted data container may be appended to the TLOG file. In another embodiment, the encrypted data container is transmitted separately from the TLOG file. The POS store server 120 may persist the new TLOG file (including the encrypted data segment) into secure storage (e.g. database 125). The POS store server 120 may send the TLOG file to the head office server 141, real time (or near real time), once a day, or at any other frequency.

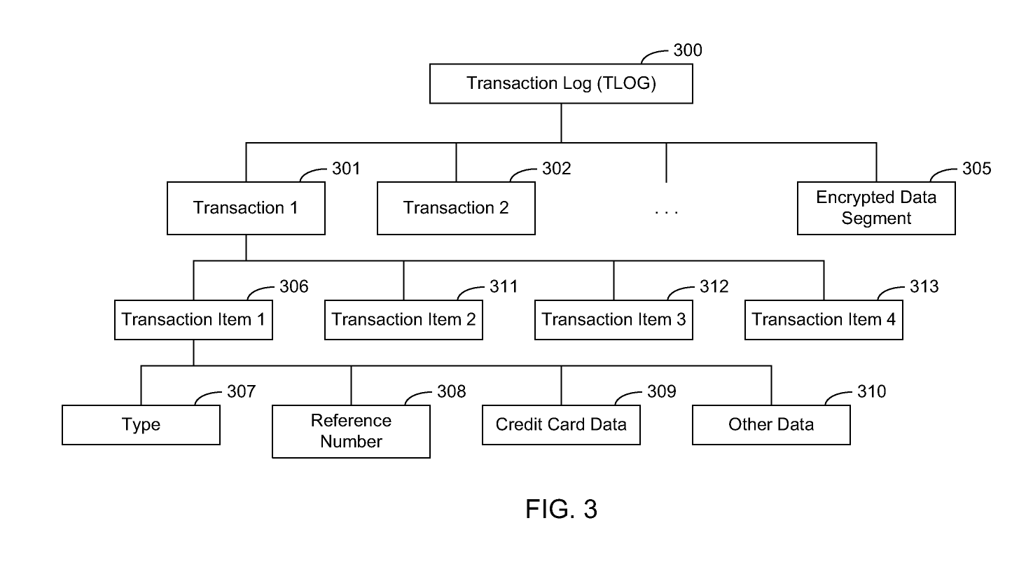

Referring to FIG. 2, FIG. 2 shows an example TLOG file 200 generated by the POS store server 120. The TLOG file 200 is shown to include a transaction data 201 section and an encrypted data segment 230. In one embodiment, the POS store server 120 generates the TLOG file 200 with transaction data for at least one transaction. Alternatively, a consolidated TLOG file may be generated at the end of the day or at any other frequency, or once in a certain period of time. The POS store server 120 receives POS sales data or TLOGs from the POS terminals 111, as discussed above. TLOGS generated by the POS terminals 111 may include encrypted credit card holder information. The TLOGs may also contain information regarding non-merchandise transactions, paid in/paid out operations, returns, exchanges, tender loans, time punches, control transactions (e.g. open/close store), loyalty points (i.e. customer loyalty program), totals and cashier statistics, etc. In one embodiment, the POS store server 120 receives a TLOG from the POS terminal 111, containing transaction data as shown in FIG. 2. In this embodiment, the POS store server 120 generates the encrypted data segment 230 and appends it to the TLOG file. The TLOG file 200 is shown in greater detail in FIG. 3.

The transaction data 201 portion of the TLOG file 200 is shown to include one or more sections (202, 204, 207, 208). More than one section may pertain to the same retail transaction. A section (202, 204, 207, 208) of the TLOG file 200 may contain sales information such as description of an item being purchased by a consumer, unit price, unit quantity, tax information, etc. The transaction data 201 of the TLOG file 200 may also include such information as retail store information, workstation information, date and time of the transaction, POS terminal or device information, transaction type, currency information, payment information, etc. The TLOG is not limited to the information listed, and may include any information relevant to a transaction or to anything that happened at the POS terminals 111. In an example embodiment, one or more sections may contain credit card holder information, including primary account number (PAN), card holder name, expiration date (validity date) of the credit card, the authorization code (security code on the back of the card), debit card information if a debit card was used to settle a transaction, and any other information payment information. For example, sections 204 and 207 are shown to include credit card information 206 and 209 respectively, whereas sections 202 and 210 are shown to include no credit card information.

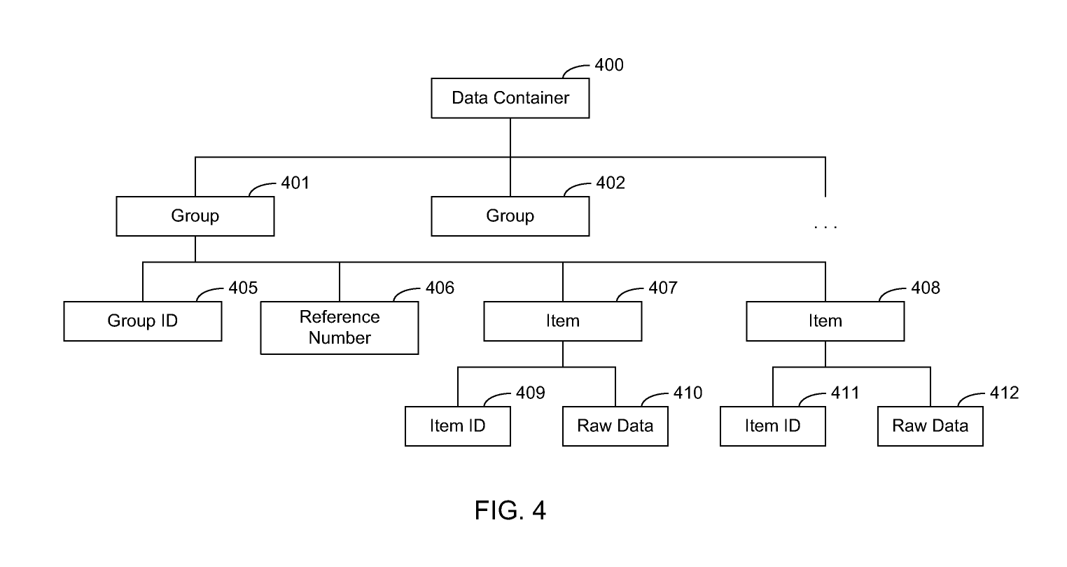

In one embodiment, the TLOG received by the POS store server 120 from a POS terminal includes encrypted credit card information, in which case the encryption logic 123 decrypts the credit card information and the data container generation logic 122 generates a data container 220 as shown in FIG. 2. The data container 220 may contain one or more groups of data (221 and 224). For example, group 221 within the data container 220 is shown to include credit card information 223 and reference 222, such that reference 222 in data container 220 matches up with reference 205 in the transaction data section of the TLOG file 200, and the credit card information 223 in the data container 220 corresponds to the credit card information 206 in the TLOG file 200. In an exemplary embodiment, all of the credit card information found in a TLOG section may be put into the data container 220. Alternatively, only certain elements (e.g. only credit card number and expiration date) of the credit card information in the TLOG may be included in the data container 220. In an example embodiment, the data container 220 will include all the credit card information from the transaction data portion of TLOG file with references back to transaction data 201. The data container 220 is shown in greater detail in FIG. 4.

In the example of FIG. 2, the POS store server 120 generated a single encrypted data segment 230 and appended it to the TLOG file 200. The encrypted data segment 230 corresponds to encrypted data container 220. The encrypted data segment 230 may be added anywhere in the TLOG file (i.e. beginning/middle/end). In another exemplary embodiment, the POS store server 120 may generate more than one encrypted data segment for a single TLOG file 200, and add these encrypted data segments to the TLOG file 200. The target systems (e.g. the data management system 160) are configured to understand the format of the encrypted data segment 230 and the format of the data container 220, so that they can decrypt the encrypted data segment 230 and interpret the retrieved data container 220 (i.e. match up the references and extract the credit card data from the data container 220).

In an exemplary embodiment, encrypted data segment 230 includes encryption method 231, which in turn may include key information 232, which in turn may include a key ID 233, and cipher data 235, which includes cipher value 236 as shown in FIG. 2. In one embodiment, encryption method 231 is not encrypted. Data container 220 may be encrypted using any encryption algorithms (symmetric, asymmetric, or hybrid assymetric), including but not limited to RSA scheme (e.g. PKCS#7), DES/DES3, Blowfish, IDEA, SEAL, Mars, RC4, SEED, etc. Cipher value 236 contains the encrypted data container 220, which is encrypted with the encryption mechanism specified in the encryption method 231. Decrypted cipher value 236 will correspond to the data container 220, and the receiving system will be able to match up the references in order to determine where in the TLOG file the decrypted credit card data belongs.

Referring to FIG. 3, a tree diagram of a TLOG 300 generated by the POS store server 120 is shown, according to an exemplary embodiment. In one embodiment, the TLOG 300 is generated by the POS store server 120. In an exemplary embodiment, the TLOG 300 may include a single encrypted data segment 305. In another embodiment, the TLOG 300 may include a plurality of encrypted data segments. The TLOG 300 may also include data for one or more transaction processed by one or more POS terminal. For each transaction (301, 302), the TLOG file may contain one or more transaction items (306, 311, 312, 313). The transaction items shown in FIG. 3 correspond to sections shown in FIG. 2. Each transaction item may also include a reference number. For example, transaction item 306 is shown to have a reference number 308. The reference number 308 corresponds to a reference number in the encrypted data segment 305, when the encrypted data segment 305 is decrypted by a receiving system (e.g. data management system 160).

Transaction item 306 is also shown to include type 307 (i.e. tender or payment, sale, charge tax, etc) and credit card data 309. The credit card data 309 may include such information as type of credit card used (e.g. VISA, Master Card, American Express, etc.), credit card number, credit card holder name, expiration date, authorization or security code.

The transaction item 306 is shown to include other data 310 which may include retail store identification, time stamp, workstation identification, business day date, begin and end date and times, application identification, organization identification, site identification, device identification, transaction type, currency, total amount saved, department, sale item information (identification, department, description, regular price, sale price, quantity), etc.

Referring to FIG. 4, a tree diagram of a data container 400 is shown, according to one exemplary embodiment. In an exemplary embodiment, the data container 400 combines the credit card information that appears in the TLOG file. The data container 400 may combine any sensitive data including other payment data, such as debit card information, medical data, etc.

The data container 400 may include one or more groups, as illustrated in FIG. 4 (group 401, group 402, etc). Group 401 is shown to include a group identification (id) 405, a reference number 406, and a plurality of items (407, 408). Each item is shown to include an item identification (id) (e.g. item id 409), and raw data (e.g. raw data 410). The reference number 406 will correspond to a reference number in the transaction data section of the TLOG 200. In an exemplary embodiment, a group contains data for a particular credit card used to make a purchase. For example, raw data 410 may include a credit card number, and raw data 411 may include credit card expiration date for that credit card. Group id 405 may identify this group as pertaining to credit card information. For example, in one embodiment, a group id having a value of 1 means that the information in the group pertains to credit card information. In an exemplary embodiment, item id may identify the item as pertaining to credit card number, expiration date of a credit card, or security code of a credit card, etc. For example, in one embodiment, if item id has a value of 1, then the raw data in this item will contain a credit card number, and if item id has a value of 2, then the raw data in this item will contain data pertaining to expiration date. In an exemplary embodiment, the meaning of group ids and item ids is defined and understood by the POS store server 120 and the data management system 160, or any other system.

Each group in data container 400 is shown in FIG. 2 to include a reference number. In an exemplary embodiment, each reference number in the data container refers back to the data in the TLOG file, such that the reference numbers in data container 400 match up with reference numbers in TLOG (for example reference number 308 may correspond to the reference number 406).

In one embodiment, a line number can be used as a reference. In another embodiment, a unique identifier can be used as a reference. For example, if the data container and TLOG are in XML format, a reference number node may be used in the data container and in the TLOG file in order to map one to the other. In another embodiment, a particular order can be used as a referencing mechanism. For example, transactions can be listed in a particular order in the TLOG and the same order can be used in the data container. The data container 400 can be in XML format, clear text format, comma separated format, binary format, etc. The data container contains raw credit card data and a referencing scheme in order to match the credit card data back to the sections in the transaction data in TLOG where they came from. In addition to the elements shown in FIG. 4, the data container 400 may contain extra elements. Alternatively, the data container 400 may not have all the elements shown in FIG. 4. The data container 400 may be implemented in a different format other than what is shown in FIG. 4.

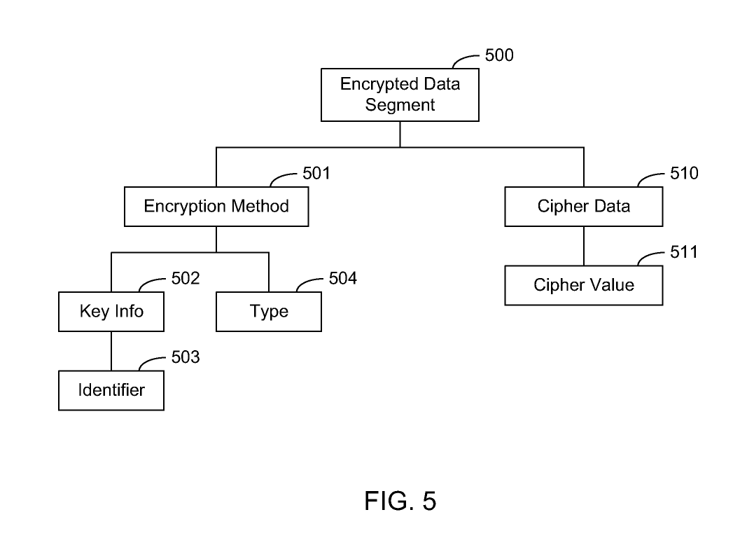

Referring to FIG. 5, a tree diagram of an encrypted data segment 500 is shown, according to an exemplary embodiment. In an exemplary embodiment, encrypted data segment 500 may contain an encrypted data container 400 (in cipher value 511), wherein the data container combines sensitive credit card information from the TLOG and contains references back to the original location within the TLOG. The encrypted data segment 500 is shown to include an encryption method 501 and a cipher data 510. The encryption method 501 may consist of an encryption algorithm that is applied to cipher data. In an exemplary embodiment, encryption method 501 is optional, and if encryption method is absent, then the encryption algorithm is known by the receiver system.

The encryption method 501 is shown to include key info 502 and type 504. The key info 502 is further shown to include an identifier 503. In an exemplary embodiment, identifier 503 may be key version id. In another exemplary embodiment, key info 502 may be used to transmit public keys, key names, etc. Type 504 may contain the type of encryption algorithm being used, including but not limited to an RSA scheme (e.g. PKCS#7), DES/DES3, Blowfish, IDEA, SEAL, Mars, RC4, or SEED, etc. In one embodiment, type 504 may be optional. In another embodiment, type 504 may be defaulted to PKCS#7.

The cipher data 510 is shown to include cipher value 511. The cipher value 511 contains the data container 400 in an encrypted form. In another embodiment, cipher data 510 may include a cipher reference element, which provides a reference to an external location containing the encrypted data. Cipher reference may include a URI and optional transforms, as well as particular transform algorithms.

In another embodiment, the data container may be encrypted using a hybrid asymmetric algorithm (e.g. using PKCS#7 standard). In this embodiment, the data container may be encrypted using a symmetric public key. The cipher value 511 may include the symmetrically encrypted data container and the symmetric public key, both encrypted using an asymmetric public key. The POS store server 120 may request the symmetric public key from the head office server 141, and may persist the symmetric public key in its own secure storage for performance and reliability reasons. In another embodiment, the head office server may generate symmetric public keys and persist them in its own secure storage. The asymmetric public key may be generated and managed by the data management system 160. The POS store server 120 may request the asymmetric public key information from the head office server 141 which in turn may request the asymmetric public key information from the data management system 160. In one embodiment, the POS store server 120 and the head office server 141 persist the asymmetric public key information in their own respective secure storages.

The encrypted data segment shown in FIG. 5 follows the W3C recommendations for XML Encryption Syntax and Processing. However, the encrypted data segment may be implemented in many other different ways. For example, in one embodiment, the encrypted data segment may be in flat file format (e.g. comma separated file). In another embodiment, the encrypted data segment may be in binary stream or file. The encrypted data segment may also be compressed.

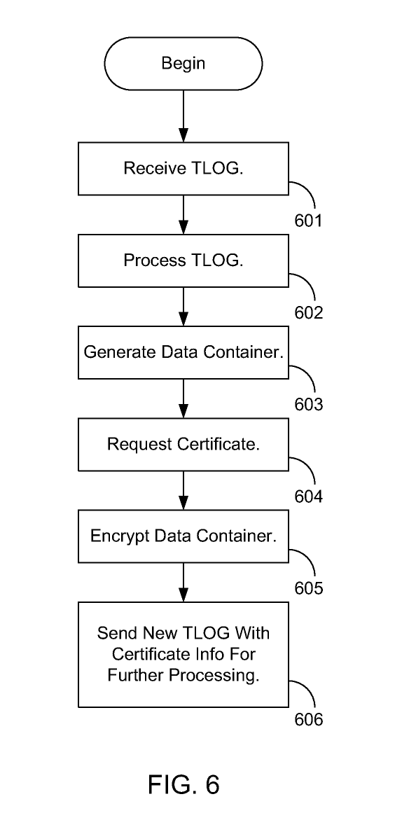

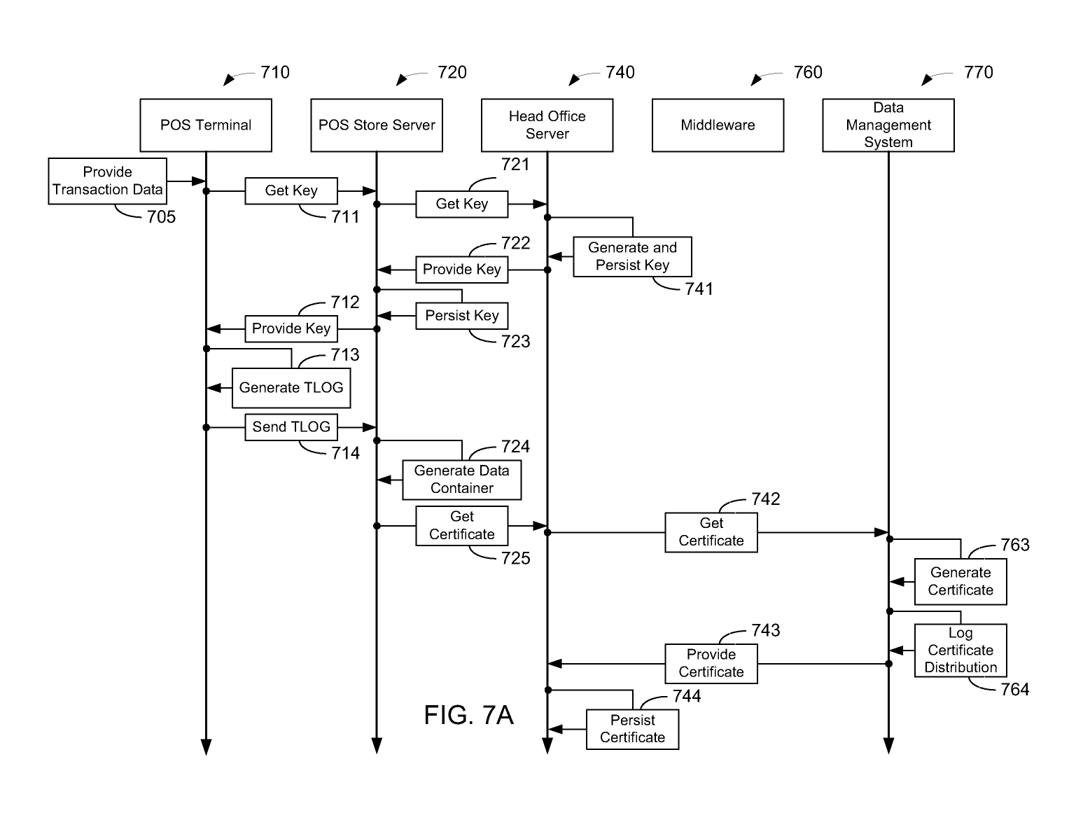

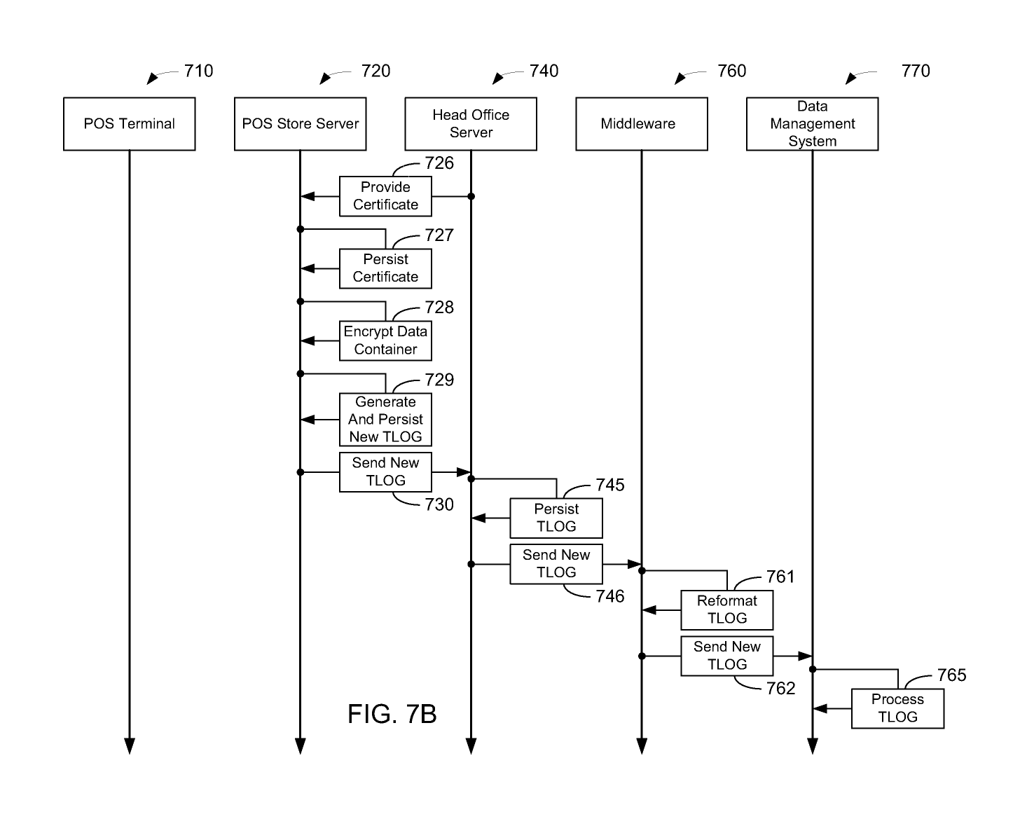

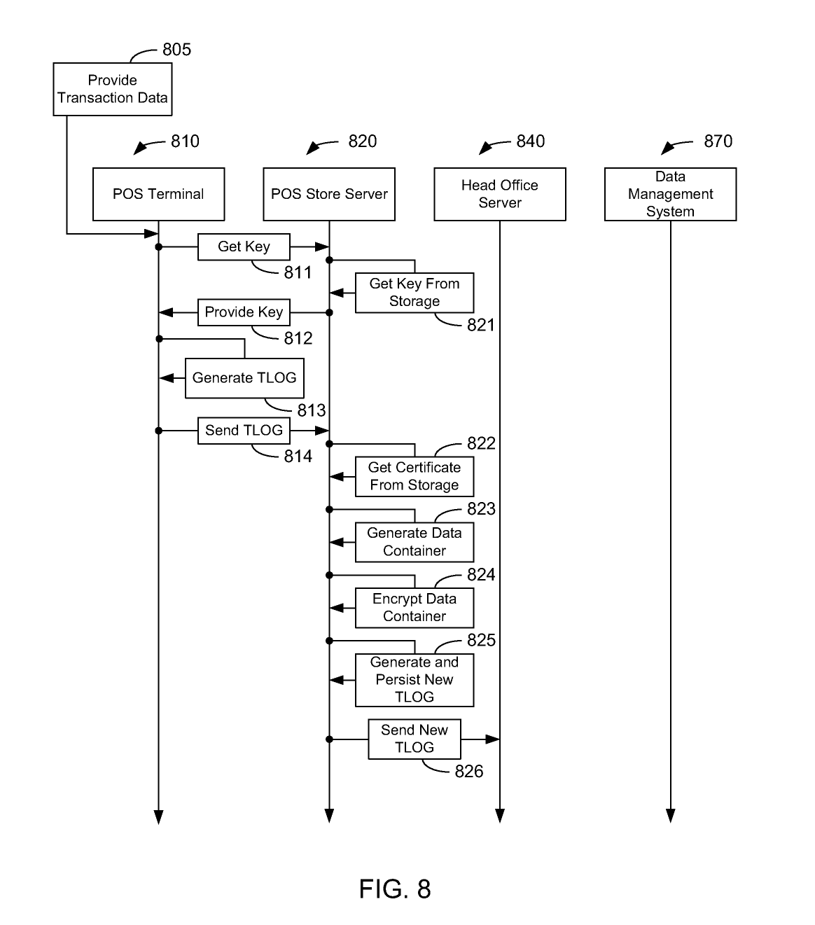

In FIG. 6, a flowchart relating to processing of TLOGs by the POS store server 120 is shown, according to an exemplary embodiment. In one embodiment, the POS store server 120 receives a TLOG from a POS terminal (step 601). At step 602, the POS store server 120 processes TLOG by decrypting any encrypted payment information. The POS store server 120 may also change format of the TLOG file. At step 603, the POS store server generates a data container, which combines sensitive payment information from the TLOG and includes references back to sections of the TLOG from which the sensitive payment information came from. An exemplary format of a data container is illustrated in FIG. 4. Next, the POS store server 120 may request a certificate in order to encrypt the data container. FIGS. 7A-7B and 8 illustrate requesting a certificate process in more detail. At step 605, the POS store server 120 may encrypt the data container using the received certification information. The POS store server 120 may append the encrypted data container to the TLOG file and transmit the new TLOG file for further processing. In one embodiment, the POS store server also transmits the key version used to encrypt the data container.

In FIGS. 7A-7B, sequence diagrams relating to TLOG transmission between systems are shown, according to an exemplary embodiment. In one embodiment, a store employee inputs transaction information, including payment information into a POS terminal 710 (step 705). If the payment information includes sensitive information (e.g. credit card information), the POS terminal 710 may request a key from the POS store server 720 in order to encrypt the sensitive data. In one embodiment, the POS store server 720 requests the key from a head office server. At step 741, the head office server 740 generates a new key and stores the newly generated key in secure key storage. Next, at step 722, the new key may be passed back to the POS store server 720, which may store the key in its own secure storage. The POS terminal 710 receives the key and generates a TLOG file, which may contain encrypted credit card information or other sensitive information. As described earlier, the TLOG file may be in any format including binary, XML, etc. The POS terminal 710 may utilize any encryption method including symmetric encryption, asymmetric encryption, hybrid asymmetric encryption, etc. In one embodiment, the POS store server 720 generates keys for the POS terminal 710 to use for encrypting the sensitive payment data. In another embodiment, the POS terminal 710 may persist keys for encrypting the sensitive payment data.

At step 724, the POS store server 770 is shown to generate a data container in a format illustrated in FIG. 4. In an exemplary embodiment, the data container combines sensitive payment data such as credit card information as well as references back to sections of the TLOG where the sensitive payment data originally came from. In one embodiment, the POS store server 720 requests a certificate from the head office server 740 in order to encrypt the generated data container. In another embodiment, the POS store server 720 requests a certificate from a data management system 770 or any other system. The head officer server 740 may then request the certificate from the data management system 770. A certificate may include a serial number, signature algorithm, issuer, valid from and valid to dates, public key, and key version. At step 763, the data management system 770 gets the certificate from its encryption logic 161. In one embodiment, the encryption logic 161 returns an existing certificate retrieved from its secure storage. In another embodiment, the encryption logic 161 generates a new certificate and stores it in its secure storage. The encryption logic 161 may activate the newly generated key. The encryption logic 161 may also maintain the versions of the keys and methods of encrypting with these keys. At step 764, the data management system 770 creates a record describing what system will be using a particular version of the public key. In one embodiment, the encryption mechanism used by the data management system 770 is asymmetric encryption, and the data management system 770 will return a certificate containing a public key and key version information to the head officer system 740.

In an exemplary embodiment, the head office server 740 persists the received certificate into its own secure storage. At steps 726, when the POS store server 720 receives the certificate from the head office server 740, it may also persist the certificate in its own secure storage. Persistence of certificates may be performed in order to improve performance, and ensure reliability. For example, the POS store server 720 performance is improved when it does not need to re-request the key every time it needs to encrypt data. Instead, the POS store server 720 may retrieve key from the secure storage and use it for encryption. In this embodiment, the POS store server 720 does not need to re-request the pubic key certificate from the head office server 740 which may be offline at that particular moment.

At step 728, the POS store server 720 encrypts the data container. In one embodiment, the POS store server 720 encrypts the data container using asymmetric encryption. In this embodiment, the POS store server 720 encrypts the data container using the certificate received from the data management system 770. The encrypted data segment 230 illustrated in FIG. 2 will include the encrypted data container in the cipher value 236 and the key ID 233 will contain the key version identification of the key used to encrypt the data container.

In another embodiment, the POS store server 720 may encrypt the data container using asymmetric hybrid encryption. Asymmetric hybrid encryption combines the symmetric encryption together with asymmetric encryption. In this embodiment, the POS store server 720 symmetrically encrypts the data container using symmetric key generated by the head office server in step 741. Then the POS store server 720 encrypts the symmetric key used to encrypt the data container and the symmetrically encrypted data container using the public certificate received from the POS data management system. In this embodiment, the cipher value 236 will contain the asymmetrically encrypted symmetric public key and the symmetrically encrypted data container. The key ID 233 will include the key version identification of the asymmetric key received at step 726.

Next, at step 729, the POS store server 720 may re-format the TLOG file received from the POS terminal 710. In an exemplary embodiment, the POS store server adds the encrypted data segment to the TLOG. Additionally, the POS store server 720 may persist the TLOG file to improve the reliability of the entire system.

The POS store server 720 may send the new TLOG, including the encrypted data container, to the head office server 740 which may also persists the TLOG (step 745), and then send the TLOG to a middleware 760. The middleware 760 may re-format TLOG. In one embodiment, the middleware 760 does not decrypt the encrypted data container and includes the encrypted data container in the TLOG file that is sent to the data management system 770 for further processing. At step 765, the data management system 770 processes the received TLOG.

In one embodiment, the data management system 770 decrypts the encrypted data container portion of the TLOG. In an exemplary embodiment, the encrypted data container may contain a key version identifier that the data management system 770 will use to decrypt the data.

In FIG. 8, a sequence diagram relating to transmission of a TLOG file is shown, according to an exemplary embodiment. After a store employee enters transaction data into a POS terminal 810 (step 805), the POS terminal 810 may request a key from a POS store server 820 in order to encrypt sensitive payment data in the transaction data. In this embodiment, the POS store server 820 may already have the key in secure storage and will retrieve the key from storage and return it back to the POS terminal 810. In another embodiment, the POS terminal 810 may persists the key in its own secure storage. At step 813, the POS terminal 810 may generate a TLOG file, encrypting the sensitive payment data found in the file with the received key. The POS store server 820 may receive the TLOG from the POS terminal 810. In one embodiment, the POS store server 820 may retrieve a certificate from its own storage. The POS store server 810 will next generated a data container as described above. At step 824, the POS store server 820 will encrypt the generated data container. In one embodiment, the POS store server 820 encrypts the data container using asymmetric encryption. In this embodiment, the POS store server 820 encrypts the data container using the certificate retrieved from the secure storage at step 822. The encrypted data segment 230 illustrated in FIG. 2 will include the encrypted data container in the cipher value 236 and the key ID 233 will contain the key version identification of the key used to encrypt the data container. In another embodiment, the POS store server 820 may encrypt the data container using asymmetric hybrid encryption. In this embodiment, the POS store server 820 symmetrically encrypts the data container using symmetric key retrieved from storage at step 821. Then the POS store server 820 encrypts the symmetric key used to encrypt the data container and the symmetrically encrypted data container using the public certificate. In this embodiment, the cipher value 836 may contain the asymmetrically encrypted symmetric public key and the symmetrically encrypted data container. The key ID 233 may contain the key version identification of the asymmetric key retrieved at steps 822.

In one embodiment, the POS store server 820 may reformat the TLOG file received from the POS terminal. In an exemplary embodiment, the POS store server 820 adds the encrypted data container to the TLOG file and sends the new TLOG to the head office server 840. At step 825, the POS store server 820 may persist the new TLOG file for performance and reliability reasons.

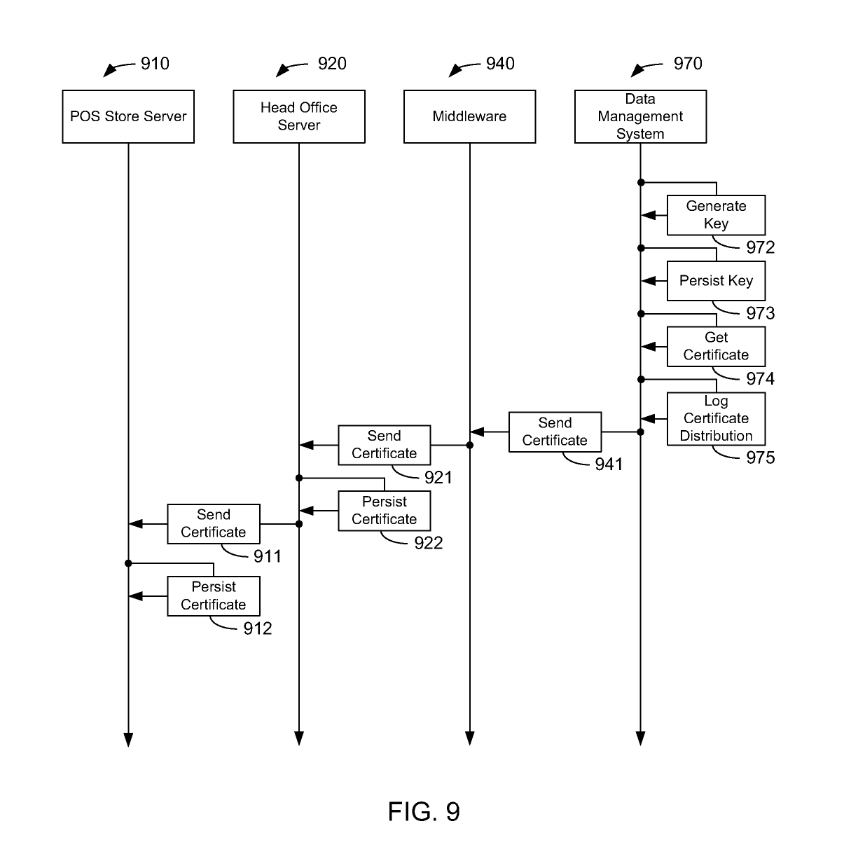

In FIG. 9, a sequence diagram relating to a process of publishing a newly generated key is shown, according to an exemplary embodiment. In one embodiment, an administrator requests that data management system 970 generates a new key. In this embodiment, a new key monitor user interface may be used by the administrator. In another embodiment, the data management system 970 itself automatically triggers generation of a new key. For example if a certain key expires or is compromised, a new key will need to be created. At step 972, the data management system 970 generates a key. In one embodiment, the newly generated key is created for a particular store. In another embodiment, the newly generated key may be created for a set of particular stores. In one embodiment, the data management system 970 utilizes symmetric mechanism in which case the data management system 970 generates a public key which will be used for encryption and decryption. In another embodiment, the data management system 970 utilizes asymmetric encryption, and the data management system 970 generates a public key and a private key, where the public key is used for encryption data and private key is used for decrypting the data. At steps 973, the data management system 970 stores the newly generated key information into its secure storage. In an exemplary embodiment, the data management system 970 prepares a certificate to be distributed to the middleware 840 (step 974). The certificate may include the public key and key version id. At step 975, the data management system 970 is shown to log the distribution of the certificate. At step 941, the middleware 940 is shown to send the certificate to a particular head office server 920. In another embodiment, the middleware 940 may send the certificate to a set of head office servers.

In one embodiment, the service that allows for newly generated public keys to be distributed to one or more locations is implemented as a web service. In an exemplary embodiment, this service does not know about the locations to distribute the key, and the middleware 940 routes the keys to appropriate locations. The data management system 970 may receive a confirmation message once the new key is distributed to the appropriate locations.

At steps 921 and 922, the head office server receives the certificate and persists it in its own secure storage. Next, the head office server 920 is shown to send the certificate to a particular store 910, which in turn persists the received certificate (step 912). In another embodiment, the head office server 920 sends the certificate to a plurality of POS stores.

Transmitting sensitive data as described herein may be applicable in other contexts aside from in-store purchases and transferring of transaction data to back end systems. For example, passing data with an encrypted data segment utilizing a referencing mechanism as described in the present invention, may be used in online transactions, or in the context of transmission of patient health information across a systems landscape (e.g., with patient identification information being stored in the data container). The present invention may also be used for transmission of any sensitive data including, but not limited to, loyalty points information, account information, payment information, etc. In addition, transmission of sensitive data in the present invention is not limited to transmission of data in the context of a retail system landscape. Sensitive data may be transmitted utilizing the encrypted data segment between any sender and receiver systems.

The disclosure is described above with reference to drawings. These drawings illustrate certain details of specific embodiments that implement the systems and methods and programs of the present disclosure. However, describing the disclosure with drawings should not be construed as imposing on the disclosure any limitations that may be present in the drawings. The present disclosure contemplates methods, systems and program products on any machine-readable media for accomplishing its operations. The embodiments of the present disclosure may be implemented using an existing computer processor, or by a special purpose computer processor incorporated for this or another purpose or by a hardwired system. No claim element herein is to be construed under the provisions of 35 U.S.C. §112, sixth paragraph, unless the element is expressly recited using the phrase “means for.” Furthermore, no element, component or method step in the present disclosure is intended to be dedicated to the public, regardless of whether the element, component or method step is explicitly recited in the claims.

As noted above, embodiments within the scope of the present disclosure include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the disclosure are described in the general context of method steps which may be implemented in one embodiment by a program product including machine-executable instructions, such as program code, for example, in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present disclosure may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, servers, minicomputers, mainframe computers, and the like. Embodiments of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the disclosure might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules, and other data for the computer.

It should be noted that although the flowcharts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the disclosure have been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated.

1. A computer system comprising machine-readable media having stored therein instructions that when executed cause the computer system to implement a method for transferring data between computer systems, the method comprising:
receiving a transaction log in a first computerized system, the transaction log including payment data;
generating a data container, by a data container generation logic implemented by the instructions stored in the machine-readable media, the data container including payment data and references to the transaction data; and
receiving a certificate from a second computerized system, the second computerized system using a first encryption mechanism;
encrypting the data container, by an encryption logic implemented by the instructions stored in the machine-readable media; and
transmitting the transaction log and the encrypted payment data to a third computerized system.

2. The computer system of claim 1, wherein the payment data received by the first computerized system was received encrypted using a second encryption mechanism.

3. The computer system of claim 2, wherein the first computerized system retrieves a first key from storage to decrypt the payment data before generating the data container.

4. The computer system of claim 1, wherein the generated data container is encrypted using the certificate, wherein the certificate contains a first key and a first key version.

5. The computer system of claim 4, wherein the certificate and the encrypted data container are encrypted using the first key, and resulting encrypted value and the first key version are appended to the transaction log.

6. The computer system of claim 4, wherein the transaction log is transmitted to a middleware system, the middleware system changing the transaction log format from a first format to a second format, and the middleware system transmitting the re-formatted transaction log to the second system.

7. The computer system of claim 6, wherein the second system decrypts the encrypted data in the transaction log using the first key version.

8. The computer system of claim 1, wherein the first encryption mechanism uses an asymmetric encryption algorithm.

9. The computer system of claim 2, wherein the second encryption mechanism uses a symmetric encryption algorithm.

10. The computer system of claim 1, wherein the first computerized system is a store server.

11. The computer system of claim 1, wherein the transaction data is received from a point of sale device.

12. The computer system of claim 1, wherein the payment data includes credit card information.

13-20. (canceled)
